(19) United States
(12) Patent Application Publication
(10) Pub. No.: US 2021/0234251 A1
(43) Pub. Date: Jul. 29, 2021

(54) ANTENNA ASSEMBLY AND MOBILE DEVICE

(71) Applicant: SZ DJI TECHNOLOGY CO., LTD., Shenzhen (CN)

(72) Inventors: Yonggen WANG, Shenzhen (CN); Fang LIU, Shenzhen (CN)

(21) Appl. No.: 17/231,930

(22) Filed: Apr. 15, 2021

Related U.S. Application Data
(63) Continuation of application No. PCT/CN2018/113202, filed on Oct. 31, 2018.

(51) Int. Cl. H01Q 1/12; H01Q 1/08; H01Q 1/00

(52) U.S. Cl. CPC H01Q 1/12; H01Q 1/002; H01Q 1/084

(57) ABSTRACT

An antenna assembly includes a fixed member, a movable member movable relative to the fixed member and including an accommodation cavity, an elastic member connecting the movable member and the fixed member, and an antenna body accommodated in the accommodation cavity.

### CROSS-REFERENCE TO RELATED APPLICATION

This application is a continuation of International Application No. PCT/CN2018/113202, filed Oct. 31, 2018, the entire content of which is incorporated herein by reference.

### TECHNICAL FIELD

The present disclosure relates to the field of antenna technology, in particular to an antenna assembly and mobile device.

### TECHNICAL BACKGROUND

Antennas are important devices for space signal transmission. With the popularization of mobile devices, the use of antennas has become more and more common. In order to maximize signal transmission performance of the antennas, the antennas are generally set at the highest end or the outermost end of the mobile devices. When an antenna collides with an obstacle, or a smart device accidentally falls, the antenna may be easily damaged caused by the load-bearing capacity and deformation limit of its own structure, for example, the antenna may fracture.

### SUMMARY

In accordance with the disclosure, there is provided an antenna assembly including a fixed member, a movable member movable relative to the fixed member and including an accommodation cavity, an elastic member connecting the movable member and the fixed member, and an antenna body accommodated in the accommodation cavity.

Also in accordance with the disclosure, there is provided a mobile device including a device body and an antenna assembly disposed at the device body. The antenna assembly includes a fixed member, a movable member movable relative to the fixed member and including an accommodation cavity, an elastic member connecting the movable member and the fixed member, and an antenna body accommodated in the accommodation cavity.

### BRIEF DESCRIPTION OF THE DRAWINGS

The above and/or additional aspects and advantages of the present disclosure will become obvious and easy to understand from the description of the embodiments in conjunction with the following drawings.

FIG. 1 is a structural diagram of a mobile device according to some embodiments of the present disclosure.

FIG. 2 is a structural diagram of a mobile device according to some embodiments of the present disclosure.

FIG. 3 is a structural diagram of a mobile device according to some embodiments of the present disclosure.

FIG. 4 is a structural diagram of a mobile device according to some embodiments of the present disclosure.

FIG. 5 is a perspective assembled view of an antenna assembly according to some embodiments of the present disclosure.

FIG. 6 is a perspective exploded view of an antenna assembly according to some embodiments of the present disclosure.

FIG. 7 is a perspective partial exploded view of an antenna assembly according to some embodiments of the present disclosure.

FIG. 8 is an enlarged view of Part VIII of the antenna assembly shown in FIG. 7.

FIG. 9 is a cross-sectional view of an antenna assembly according to some embodiments of the present disclosure.

### DESCRIPTION OF REFERENCE NUMERALS FOR MAIN COMPONENTS

Antenna assembly 10, Movable member 11, Accommodation cavity 111, Movable member base 112, First positioning member 1122, First fixing column 1124, Movable member cover 113, Second positioning member 1132, Second fixing column 1134, Movable member connection end 114, First wiring hole 1142, First connection column 1144, Movable member free end 115, Antenna positioning column 1152, Fixed member 12, Accommodation chamber 121, Fixed member base 122, First coupling member 1222, First coupling column 1224, Fixed member cover 123, Second coupling member 1232, Second coupling column 1234, Fixed member connection end 124, Second wiring hole 1242, Second connection column 1244, Fixed member free end 125, Side surface 126, Opening 1262, Mounting member 127, Through hole 1272, Elastic member 13, First end 132, Second end 134, Antenna body 14, Circuit board 141, Antenna positioning hole 1412, Feed line 142, Protective part 15, First connection member 152, Protective member 154, Second connection member 156, Connection hole 157, Device body 30, Side surface 32, Rotation axis 34, and Mobile device 100.

### DETAILED DESCRIPTION OF THE EMBODIMENTS

Some embodiments of the present disclosure are described in detail below. Examples of the embodiments are shown in the accompanying drawings, where the same or similar reference numerals indicate the same or similar elements or elements with the same or similar functions. The following embodiments described with reference to the accompanying drawings are exemplary, and are only used to explain the present disclosure, and should not be understood as a limitation to the present disclosure.

In the description of the present disclosure, it should be understood that the terms “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” and other directions or positional relationships are based on the orientation or positional relationship shown in the drawings, are only for the convenience of describing the application and simplifying the description, and do not indicate or imply that the device or element referred to must have a specific orientation, be constructed, and operated in a specific orientation. Therefore, they should not be understood as a restriction on the present disclosure. In addition, the terms “first” and “second” are only used for descriptive purposes, and should not be understood as indicating or implying relative importance or implicitly indicating the number of indicated technical features. Therefore, the features defined with “first” and “second” may explicitly or implicitly include one or more of the features. In the description of the present disclosure, “multiple” means two or more than two, unless otherwise specifically defined.

In the description of the present disclosure, it should be noted that the terms “mounting,” “connection,” and “coupling” should be interpreted broadly unless otherwise clearly specified and limited. For example, it can be a fixed connection, a detachable connection, or an integrated connection. It can be a mechanical connection or an electrical connection. It can be direct connection, or indirect connection through an intermediate medium, and it can be a communication between two elements or an interaction relationship between two elements. For those of ordinary skill in the art, the specific meanings of the above terms in the present disclosure can be understood according to specific circumstances.

The disclosure below provides many different embodiments or examples to realize the different structures of the present disclosure. In order to simplify the disclosure of the present disclosure, the components and settings of specific examples are described above. Of course, they are only examples and are not intended to limit the present disclosure. In addition, the present disclosure may repeat reference numerals and/or reference letters in different examples. Such repetition is for the purpose of simplification and clarity, and does not indicate the relationship between the various embodiments and/or settings discussed. In addition, the present disclosure provides examples of various specific processes and materials, but those of ordinary skill in the art may be aware of the application of other processes and/or the use of other materials.

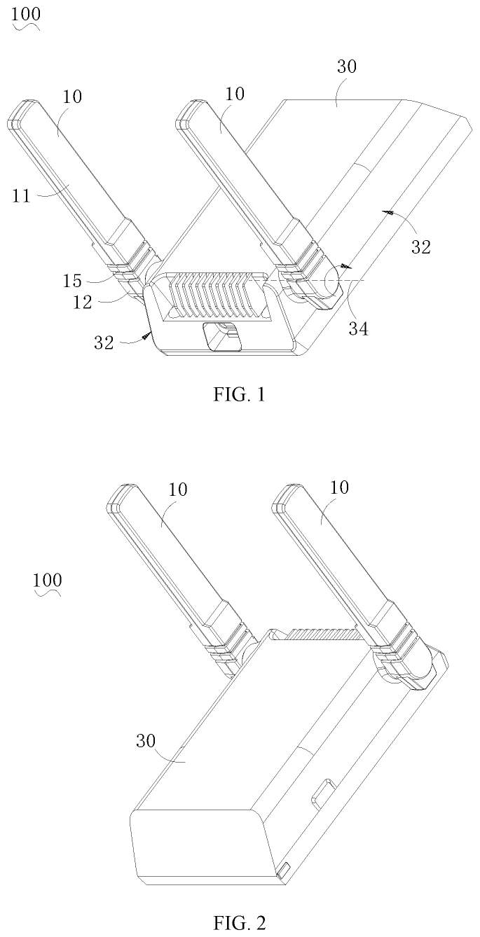

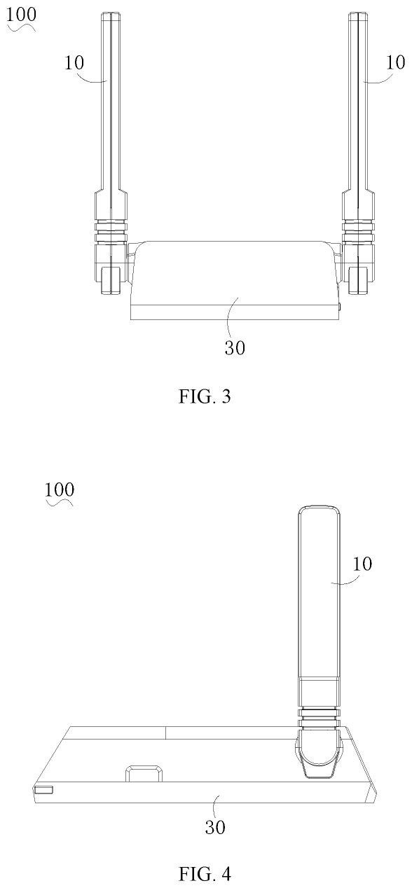

Referring to FIGS. 1-4 together, a mobile device 100 according to an embodiment of the present disclosure includes a device body 30 and an antenna assembly 10. The mobile device 100 may be a device capable of moving, such as a handheld gimbal, a mobile vehicle, a mobile robot, and an unmanned aerial vehicle, etc.

The antenna assembly 10 is disposed at the device body 30. In some embodiments, the antenna assembly 10 may be provided at a side surface 32 of the device body 30. The device body 30 can drive the antenna assembly 10 to move together. The number of antenna assembly 10 may be one or more than one. When the number of antenna assembly 10 is more than one, the more than one antenna assemblies 10 may be symmetrically arranged at the device body 30. For example, in FIG. 1, the number of antenna assemblies 10 is two, and the two antenna assemblies 10 are symmetrically arranged at opposite sides of the device body 30. It can be understood that when the number of antenna assembly 10 is three, four, or more, the plurality of antenna assemblies 10 may also be symmetrically arranged in various positions at the device body 30.

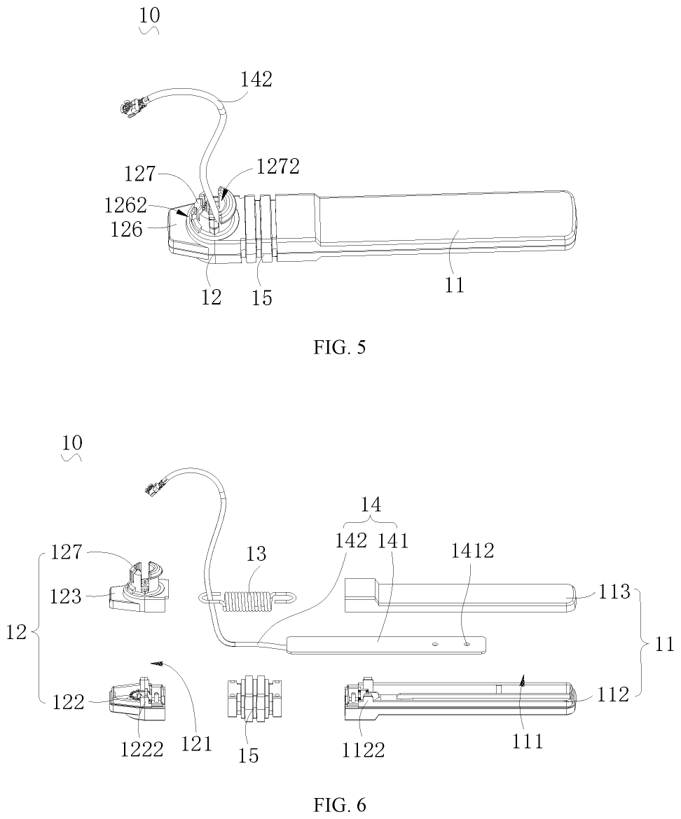

Referring to FIGS. 5 and 6, the antenna assembly 10 includes a movable member 11, a fixed member 12, an elastic member 13, an antenna body 14, and a protective part 15.

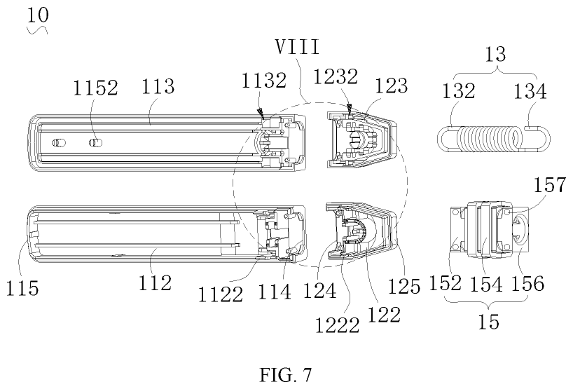

The movable member 11 has a hollow elongated structure. The movable member 11 is configured with an accommodation cavity 111, and the accommodation cavity 111 is configured to accommodate the antenna body 14. In some embodiments, the antenna body 14 may be partially accommodated in the accommodation cavity 111. The movable member 11 includes a movable member base 112 and a movable member cover 113. The movable member base 112 and the movable member cover 113 together form the accommodation cavity 111. The movable member base 112 can be connected to the movable member cover 113 by any one or more methods of welding, snapping, screwing, or gluing. Referring to FIG. 7, a first positioning member 1122 is provided at a side of the movable member base 112 where the movable member base 112 is connected to the movable member cover 113, and a second positioning member 1132 is provided at a side of the movable member cover 113 where the movable member cover 113 is connected to the movable member base 112. When the movable member base 112 is connected to the movable member cover 113, the first positioning member 1122 matches the second positioning member 1132. The number of the first positioning member 1122 and the second positioning member 1132 may both be one or more. The first positioning member 1122 may be a convex structure (such as a positioning post), and in this case, the second positioning member 1132 is a concave structure (such as a positioning hole); or the first positioning member 1122 is a concave structure, and the second positioning member 1132 is convex structure; or the number of the first positioning member 1122 and the second positioning member 1132 are multiple, some of the first positioning members 1122 are convex structures, and the rest of the first positioning members 1122 are concave structures, and correspondingly, some of the second positioning members 1132 are concave structures, and the rest second positioning members 1132 are convex structures. In some embodiments of the present disclosure, the movable member base 112 and the movable member cover 113 are first positioned and matched with each other through the first positioning member 1122 and the second positioning member 1132, and then joined together by welding, so that the positioning is accurate and relatively stable.

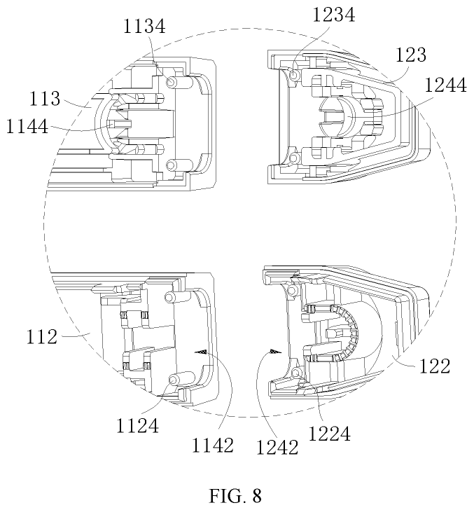

Continuing referring to FIG. 7, the movable member 11 includes a movable member connection end 114 and a movable member free end 115 opposite to each other. The movable member free end 115 is in a closed state, and the movable member connection end 114 is in an open state. The movable member free end 115 may be provided with one or more antenna positioning columns 1152. Referring to FIG. 8, the movable member connection end 114 is configured with a first wiring hole 1142. The movable member connection end 114 is also provided with a first connection column 1144 in the accommodation cavity 111. The first connection column 1144 may be located on a side of the movable member connection end 114 where the movable member base 112 is located, or on a side of the movable member connection end 114 where the movable member cover 113 is located (as shown in FIG. 8). The number of the first connection columns 1144 can be one or more than one. When the number of the first connection columns 1144 is more than one, the plurality of first connection columns 1144 may be arranged at intervals to form an arc structure.

Referring to FIG. 1 again, the fixed member 12 is connected to the device body 30. In some embodiments, the fixed member 12 may be fixedly connected to the device body 30; or, the fixed member 12 may be rotatably connected to the device body 30. When the fixed member 12 is rotatably connected to the device body 30, the fixed member 12 rotates relative to the device body 30 around a rotation axis 34 that is perpendicular to the side surface 32 of the device body 30. Since the fixed member 12 is rotatably connected to the device body 30, the degree of freedom of the antenna assembly 10 operation is increased. When the mobile device 100 needs to accommodate the antenna assembly 10, the fixed member 12 can be rotated around the rotation axis 34 to realize the storage of the antenna assembly 10 at the side surface 32. Of course, in other embodiments, one more rotation axis (or two rotation axes) can also be added between the mobile device 100 and the antenna assembly 10, that is, the antenna assembly 10 is connected to the mobile device 100 through two rotation axes (or three rotation axes) to realize rotation with two degrees of freedom (or three degrees of freedom).

Referring to FIG. 6, the fixed member 12 is configured with an accommodation chamber 121. In some embodiments, the fixed member 12 includes a fixed member base 122, a fixed member cover 123, and a mounting member 127, where the fixed member base 122 and the fixed member cover 123 together form the accommodation chamber 121. The fixed member base 122 is connected to the fixed member cover 123 by any one or more of welding, clamping, screwing, or gluing. Referring to FIG. 7, a first coupling member 1222 is provided at a side of the fixed member base 122 where the fixed member base 122 is connected to the fixed member cover 123, and a second coupling member 1232 is provided at a side of the fixed member base 122 where the fixed member cover 123 is connected to the fixed member base. When the fixed member base 122 is connected to the fixed member cover 123, the first coupling member 1222 matches the second coupling member 1232. The number of the first coupling member 1222 and the second coupling member 1232 may both be one or more than one. The first coupling member 1222 may be a convex structure (such as a positioning post); and in this case, the second coupling member 1232 is a concave structure (such as a positioning hole); or, the first coupling member 1222 is a concave structure, and the second coupling member 1232 is convex structure; or, the number of the first coupling member 1222 and the second coupling member 1232 are both more than one, some of the first coupling members 1222 are convex structures, and the rest first coupling members 1222 are concave structures, correspondingly, some of the second coupling members 1232 are concave structure, and the rest second coupling members 1232 are convex structures. In some embodiments of the present disclosure, the fixed member base 122 and the fixed member cover 123 are first positioned and matched with each other through the first coupling member 1222 and the second coupling member 1232, and then connected to each other by welding, so that the positioning is accurate and relatively stable.

Continuing referring to FIG. 7, the fixed member 12 includes a fixed member connection end 124 and a fixed member free end 125 opposite to each other. The fixed member free end 125 is in a closed state, and the fixed member connection end 124 is in an open state. Referring to FIG. 8, the fixed member connection end 124 is configured with a second wiring hole 1242. The fixed member connection end 124 is also provided with a second connection column 1244 in the accommodation chamber 121. The second connection column 1244 may be located on a side of the fixed member connection end 124 where the fixed member base 122 is located, or on the side of the fixed member connection end 124 where the fixed member cover 123 is located (as shown in FIG. 8). The number of the second connection columns 1244 can be one or more than one. When the number of the second connection columns 1244 is more than one, the plurality of second connection columns 1244 may be arranged at intervals to form an arc structure.

Referring to FIG. 5, the fixed member 12 further includes a side surface 126 between the fixed member connection end 124 and the fixed member free end 125. The side surface 126 is ring-shaped, and the side surface 126 may refer to a surface of the fixed member cover 123 that is opposite to the fixed member base 122, or a surface of the fixed member base 122 that is opposite to the fixed member cover 123. For example, in FIG. 5, the side surface 126 is the surface of the fixed member cover 123 that is opposite to the fixed member base 122. The fixed member 126 also includes an opening 1262 on the side surface 126. The opening 1262 penetrates the fixed member cover 123.

The mounting member 127 extends from the side surface 126. The mounting member 127 includes a through hole 1272 connected to the opening 1262, and a central axis of the through hole 1272 is perpendicular to an extending direction of the fixed member 12. It should be pointed out that the extending direction of the fixed member 12 is the direction between the movable member 11 and the fixed member 12, and the direction is parallel or coincident with a length direction of the antenna assembly 10. When the fixed member 12 is connected to the device body 30, the mounting member 127 and the device body 30 structurally match with each other, and the central axis of the through hole 1272 is perpendicular to the extending direction of the fixed member 12 to facilitate the installation of the mounting member 127 to the device body 30.

Referring to FIG. 6, the elastic member 13 connects the movable member 11 and the fixed member 12. The movable member 11 and the fixed member 12 can move relative to each other. When the antenna assembly 10 collides with an obstacle, or the smart device accidentally falls, the movable member 11 can move relative to the fixed member 12, or the fixed member 12 can move relative to the movable member 11, so as to avoid damage to the antenna assembly 10 due to exceeding the load-bearing capacity and deformation limit of its own structure, and to improve the destructive resistance of the antenna assembly 10 when the antenna assembly 10 is impacted in all directions or when the mobile device 100 falls, thereby effectively protecting the antenna body 14 to ensure the long life time of the antenna assembly 10, and satisfying the use of the antenna assembly 10 in various mobile environments. In addition, when the mobile device 100 needs to accommodate the antenna assembly 10, the movable member 11 and the fixed member 12 can also be moved relative to each other to realize the omnidirectional folding of the antenna assembly 10, and to achieve the optimization of the design of the antenna assembly 10, without adding too many structural parts and assembly processes.

With the connection of the elastic member 13, the movable member 11 can telescopically move relative to the fixed member 12 in a first direction, where the first direction is an extension direction of the elastic member 13. In some embodiments of the present disclosure, the first direction is also parallel to or coincides with the direction between the movable member 11 and the fixed member 12 and the longitudinal direction of the antenna assembly 10. The connection between the elastic member 13 and the fixed member 12 forms a joint point, and the movable member 11 can rotate in various directions around the joint point as a fixed point. In the antenna assembly 10 of some embodiments of the present disclosure, through connecting the movable member 11 to the fixed member 12 via an elastic member 13, the movable member 11 can be rotated 360 degrees around the joint point as a fixed point, so as to achieve omnidirectional adjustment with equal torque in all directions and equal displacement in all directions.

Referring to FIGS. 7 and 8, the elastic member 13 includes a first end 132 and a second end 134 opposite to each other. The first end 132 of the elastic member 13 extends though the first wiring hole 1142 into the accommodation cavity 111 and is connected to the first connection column 1144. The second end 134 of the elastic member 13 extends into the accommodation chamber 121 through the second wiring hole 1242 and is connected to the second connection column 1244 so as to achieve firm connection of the elastic member 13 to the movable member 11 and the fixed member 12. In some embodiments of the present disclosure, the elastic member 13 is a spring. The spring can be used as the best carrier for omnidirectional bending, and can also withstand a certain tension or pressure in the axial direction, thereby protecting the internal structure of the antenna assembly 10 and ensuring the distance between the movable member 11 and the fixed member 12. In addition, the spring also has a centering characteristic of restored elastic force, and can be restored to the optimal functional orientation of the antenna assembly 10 after the movable member 11 and the fixed member 12 move relative to each other. Of course, in other embodiments, the elastic member 13 may also be other elements with elastic restoring capability. When the elastic member 13 is a spring, the first end 132 and the second end 134 are both hooks, and the hooks are fixedly connected to the first connection column 1144 and the second connection column 1244, respectively, to prevent the elastic member 13 falls off from the movable member 11 and/or the fixed member 12 due to tension or pressure, when the movable member 11 and the fixed member 12 relative move. When multiple first connection columns 1144 and/or multiple second connection columns 1244 are arranged at intervals to form an arc structure, the first end 132 and the second end 134 of the elastic member 13 can be better fixedly connected to the first connection column 1144 and/or the second connection column 1244.

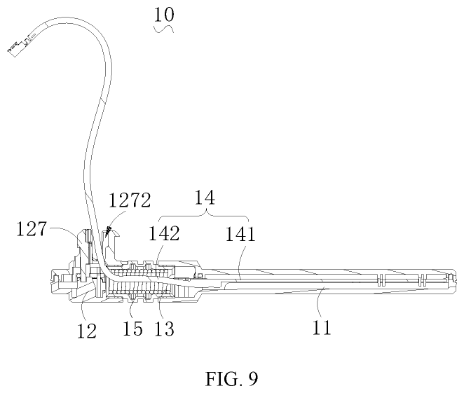

Referring to FIGS. 5 to 7 and FIG. 9, the antenna body 14 includes a circuit board 141 and a feed line 142. The circuit board 141 is accommodated in the accommodation cavity 111. The circuit board 141 may be a flexible printed circuit (FPC), a printed circuit board (PCB), or a rigid-flex-combined board, etc. One or more antenna positioning holes 1412 may be disposed at the circuit board 141. The antenna positioning hole 1412 cooperates with the antenna positioning column 1152 to position the circuit board 141, so that the circuit board 141 is stably accommodated in the accommodation cavity 111. One terminal of the feed line 142 is connected to the circuit board 141, and the other terminal of the feed line 142 successively passes through the elastic member 13 and the accommodation chamber 121 of the fixed member 12, and passes out from the opening 1262 of the fixed member 12 through the through hole 1272 of the mounting member 127. The other terminal of the feed line 142 is also connected to the control end of the device body 30. The feed line 142 is sleeved by the elastic member 13 (passing through the center of the elastic member 13), which can play a role of safety protection for connection, and can also ensure the best clearance area for the antenna radio frequency. When the antenna assembly 10 emits electromagnetic waves, the circuit board 141 radiates electromagnetic energy (EM) to the free space outside the antenna assembly 10; when the antenna assembly 10 receives electromagnetic waves, the circuit board 141 transmits the electromagnetic energy to the feed line 142, and the feed line 142 transmits the electromagnetic energy to the control end of the device body 30.

Referring to FIGS. 6 and 7, the protective part 15 sleeves at the elastic member 13 and is located between the movable member 11 and the fixed member 12. The protective part 15 is made of soft rubber material, such as silica gel, rubber, etc. The protective part 15 includes a first connection member 152, a protective member 154, and a second connection member 156 connected in sequence. The first connection member 152, the protective member 154, and the second connection member 156 all have a ring shape. The first connection member 152, the protective member 154, and the second connection member 156 may be integrally formed, or may be formed separately. The protection part 154 is formed with wrinkles to provide a deformation space for the elastic member 13. The first connection member 152 is accommodated in the accommodation cavity 111, and the second connection member 156 is accommodated in the accommodation chamber 121, so that the antenna assembly 10 can appear beautiful and the antenna assembly 10 can be sealed, thereby preventing the performance of the antenna assembly 10 from being affected caused by debris entering the antenna assembly 10 through the connection point between the elastic member 13 and the movable member 11 and/or the connection point between the elastic member 13 and the fixed member 12.

Furthermore, referring to FIG. 8, a side of the movable member base 112 that is connected to the movable member cover 113 may be provided with a first fixing column 1124, where the first fixing column 1124 passes through the first connection member 152; and/or the a side of the movable member cover 113 that is connected to the movable member base 112 is provided with a second fixing column 1134, where the second fixing column 1134 passes through the first connection member 152; and/or a side of the fixed member base 122 that is connected to the fixed member cover 123 is provided with a first coupling column 124 where the first coupling column 1224 passes through the second connection member 156; and/or the a side of the fixed member cover 123 that is connected to the fixed member base 122 is provided with a second coupling column 1234, and the second connection column 1234 passes through the second connection member 156. In some embodiments, the first connection member 152 and the second connection member 156 are each configured with a connection hole 157, and the first fixing column 1124 and the first coupling column 1224 passes into the connection hole 157, so that the first connection member 152 can be stably accommodated in the accommodation cavity 111, and the second connection member 15 can be stably accommodated in the accommodation chamber 121. In some embodiments of the present disclosure, the number of the first fixing column 1124, the second fixing column 1134, the first coupling column 1224, and the second coupling column 1234 are all two, and the number of the connection holes 157 on the first connection member 152 and the second connection member 156 are all four, so as to cooperate with the first fixing column 1124, the second fixing column 1134, the first coupling column 1224, and the second coupling column 1234, respectively.

In summary, in the antenna assembly 10 and the mobile device 100 of some embodiments of the present disclosure, the antenna body 14 is accommodated in the accommodation cavity 111 of the movable member 11, and the movable member 11 and the fixed member 12 can move relative to each other. When the antenna assembly 10 collides with an obstacle, or the smart device accidentally falls, the movable member 11 can move relative to the fixed member 12, or the fixed member 12 can move relative to the movable member 11 to avoid damage to the antenna assembly 10 due to exceeding the load-bearing capacity and deformation limit of its own structure, and to improve the destructive resistance of the antenna assembly 10 when the antenna assembly 10 is impacted in all directions or when the mobile device 100 falls, thereby effectively protecting the antenna body 14 to ensure the long life time of the antenna assembly 10, and satisfying the use of the antenna assembly 10 in various mobile environments. In addition, when the mobile device 100 needs to accommodate the antenna assembly 10, the movable member 11 and the fixed member 12 can also be moved relative to each other to realize the omnidirectional folding of the antenna assembly 10, and to achieve the optimization of the design of the antenna assembly 10, without adding too many structural parts and assembly processes.

In the description of this specification, the description with reference to the terms “certain embodiment,” “an embodiment,” “some embodiments,” “exemplary embodiments,” “examples,” “specific examples,” or “some examples,” etc., means that combinations of the specific features, structures, materials, or characteristics described by the embodiments or the examples may be included in at least one embodiment or example of the present disclosure. In this specification, the schematic representations of the above terms do not necessarily refer to the same embodiment or example. Moreover, the described specific features, structures, materials, or characteristics can be combined in an appropriate manner in any one or more embodiments or examples.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include one or more of the features. In the description of the present disclosure, “multiple” means two or more than two, unless otherwise specifically defined.

Although some embodiments of the present disclosure have been shown and described above, it can be understood that the above embodiments are exemplary and should not be understood as a limitation to the present disclosure. Those of ordinary skill in the art can make, adjustments, modifications, substitutions and variations to the embodiments within the scope of the present invention. The scope of the present invention is defined by the claims and their equivalents.

What is claimed is:

1. An antenna assembly comprising:
a fixed member;
a movable member movable relative to the fixed member and including an accommodation cavity;
an elastic member connecting the movable member and the fixed member; and
an antenna body accommodated in the accommodation cavity.

2. The antenna assembly according to claim 1, wherein the movable member includes:
a movable member base; and
a movable member cover connected to the movable member base, the movable member base and the movable member cover together forming the accommodation cavity.

3. The antenna assembly according to claim 2, wherein the movable member base is connected to the movable member cover by at least one of welding, snapping, screwing, or gluing.

4. The antenna assembly according to claim 2, wherein the movable member further includes:
a first positioning member provided at a side of the movable member base that is connected to the movable member cover; and
a second positioning member matching the first positioning member and provided at a side of the movable member cover that is connected to the movable member base.

5. The antenna assembly according to claim 1, wherein the antenna body includes:
a circuit board accommodated in the accommodation cavity; and
a feed line connected to the circuit board, the feed line passing through in turn the elastic member and the fixed member, and passing out from an opening of the fixed member.

6. The antenna assembly according to claim 5, wherein the fixed member includes:
a fixed member base;
a fixed member cover connected to the fixed member base; and
an accommodation chamber formed by the fixed member base and the fixed member cover, the feed line passing through the accommodation chamber.

7. The antenna assembly according to claim 6, wherein the fixed member base is connected to the fixed member cover by at least one of welding, snapping, screwing, or gluing.

8. The antenna assembly according to claim 6, wherein the fixed member further includes:
a first coupling member provided at a side of the fixed member base that is connected to the fixed member cover, and
a second coupling member matching the first coupling member and provided at a side of the fixed member cover that is connected to the fixed member base.

9. The antenna assembly according to claim 6, wherein:
the movable member further includes:
a movable member connection end including a first wiring hole; and
a movable member free end opposite to the movable member connection end;
the fixed member further includes:
a fixed member connection end including a second wiring hole; and
a fixed member free end opposite to the fixed member connection end; and
a first end of the elastic member extends into the accommodation cavity through the first wiring hole, and a second end of the elastic member extends into the accommodation chamber from the second wiring hole.

10. The antenna assembly according to claim 9, wherein:
the movable member connection end further includes a first connection column in the accommodation cavity;
the fixed member connection end further includes a second connection column in the accommodation chamber; and
the first end of the elastic member is connected to the first connection column, and the second end of the elastic member is connected to the second connection column.

11. The antenna assembly according to claim 9, wherein the fixed member further includes a side surface located between the fixed member connection end and the fixed member free end, the opening of the fixed member being provided at the side surface of the fixed member.

12. The antenna assembly according to claim 11, wherein the fixed member further includes:
a mounting member extending from the side surface of the fixed member, the mounting member including a through hole communicating with the opening, a central axis of the through hole being perpendicular to an extension direction of the fixed member, and the feed line passing through the through hole.

13. The antenna assembly according to claim 1, further comprising:
a protective part sleeving at the elastic member and located between the movable member and the fixed member.

14. The antenna assembly according to claim 13, wherein the protective part includes a first connection member, a protective member, and a second connection member that are sequentially connected to each other, the first connection member being received in the accommodation cavity, and the second connection member being accommodated in the accommodation chamber of the fixed member.

15. The antenna assembly according to claim 14, wherein:
the movable member further includes at least one of:
a first fixing column provided at a side of the movable member base that is connected to the movable member cover, the first fixing column passing through the first connection member; or
a second fixing column provided at a side of the movable member cover that is connected to the movable member base, the second fixing column passing through the first connection member; or
the fixed member further includes at least one of:
a first coupling column provided at a side of the fixed member base that is connected to the fixed member cover, the first coupling column passing through the second connection member; or
a second coupling column provided at a side of the fixed member cover that is connected to the fixed member base, the second coupling column passing through the second connection member.

16. The antenna assembly according to claim 13, wherein the protective part is made of a soft rubber material.

17. The antenna assembly according to claim 1, wherein the elastic member includes a spring.

18. The antenna assembly according to claim 1, wherein:
the movable member is telescopically movable relative to the fixed member in an extension direction of the elastic member; and
a connection between the elastic member and the fixed member forms a joint point, the movable member is rotatable in one or more directions with the joint point as a fixed point.

19. A mobile device comprising:
a device body; and
an antenna assembly disposed at the device body and including:
a fixed member;
a movable member movable relative to the fixed member and including an accommodation cavity;
an elastic member connecting the movable member and the fixed member; and
an antenna body accommodated in the accommodation cavity.

20. The mobile device according to claim 19, wherein:
the antenna assembly is arranged at a side surface of the device body of the mobile device; and
the fixed member is rotatably connected to the device body.
